(19) United States
(12) Patent Application Publication
(10) Pub. No.: US 2010/0303231 A1
(43) Pub. Date: Dec. 2, 2010

(54) UPDATING CRYPTOGRAPHIC KEY DATA

(75) Inventors: Paulus Mathias Hubertus Mechtildis Antonius Gorissen, Eindhoven (NL); Wilhelmus Petrus Adrianus Johannus Michiels, Eindhoven (NL); Marcel Lambertus Leonardus Bijsterveld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/600,057

(22) PCT Filed: May 14, 2008
(86) PCT No.: PCT/IB2008/051902

§ 371 Date: Nov. 13, 2009

(30) Foreign Application Priority Data
May 22, 2007 (EP) 07108581.5

(51) Int. Cl. H04N 7/167; H04L 9/06; H04L 9/08

(52) U.S. Cl. 380/210; 380/279; 380/28; 380/277

(57) ABSTRACT

A system 100 for updating cryptographic key data 120 comprises a key input 106 for receiving sequential key updates 114; and a key data updater 108 for changing a portion (116) of the cryptographic key data in response to a received one of the sequential key updates (114), the portion not including all the cryptographic key data, wherein different respective portions of the cryptographic key data are selected for respective ones of the sequential key updates. The system further comprises a content input 104 for receiving content data 112 to be processed; and a cryptographic unit 110 for cryptographic processing of the content data in dependence on the key data to obtain processed content data 118. The content input is arranged for receiving a content data stream, successive portions of the content data stream being encrypted based on successive keys corresponding to the successive key updates.

### FIELD OF THE INVENTION

The invention relates to updating cryptographic key data.

### BACKGROUND OF THE INVENTION

The use of the Internet as a distribution medium for copyrighted content has created the challenge to secure the interests of the content provider. In particular it is required to warrant the copyrights and business models of the content providers. Increasingly, consumer electronics platforms are operated using a processor loaded with software. Such software may provide the main part of the functionality for rendering (playback) of digital content, such as audio and/or video. One way to enforce the interests of the content owner including the terms and conditions under which the content may be used, is by having control over the playback software. Where traditionally many consumer electronics platforms implemented in for example televisions or DVD players used to be closed, nowadays more and more platforms at least partially are open. This applies in particular to the PC platform, because some users may be assumed to have complete control over the PC hardware and software that provides access to the content. Also, such users may be assumed to have a large amount of time and resources to attack and bypass any content protection mechanisms. As a consequence, content providers must deliver content to legitimate users across an insecure network and to a community where not all users or devices can be trusted.

Digital rights management systems often use encryption methods to prevent unauthorized use of content and/or digital signature methods to enable tracking the source of illegally distributed content. One of the issues arising in digital rights management is that the software code that enforces the terms and conditions under which the content may be used must not be tampered with.

Two areas of vulnerability of digital rights management relying on encryption are the software plug-ins which enforce the terms and conditions under which the content may be used, and the key distribution and handling. An attacker aiming to remove the enforcement of the terms and conditions may attempt to achieve this through tampering of the program code comprised in the software plug-in. In relation to key handling, for playback a media player has to retrieve a decryption key from a license database. It then has to store this decryption key somewhere in memory for the decryption of the encrypted content. This provides an attacker with two options for an attack on the key. Firstly, reverse engineering of the license database access function could result in black box software (i.e., the attacker does not have to understand the internal workings of the software function), allowing the attacker to retrieve asset keys from all license databases. Secondly, by observation of the accesses to memory during content decryption, it may be possible to retrieve the asset key. In both cases the key is considered to be compromised.

Tamper-resistant software denotes software that has special features to complicate goal-directed tampering. Various techniques for increasing the tamper resistance of software applications exist. Most of these techniques are based on hiding the embedded knowledge of the application by adding a veil of randomness and complexity in both the control and the data path of the software application. The idea behind this is that it becomes more difficult to extract information merely by code inspection. It is therefore more difficult to find the code that, for example, handles access and permission control of the application, and consequently to change it.

“White-Box Cryptography and an AES Implementation”, by Stanley Chow, Philip Eisen, Harold Johnson, and Paul C. Van Oorschot, in Selected Areas in Cryptography: 9^{th} Annual International Workshop, SAC 2002, St. John's, Newfoundland, Canada, Aug. 15-16, 2002, referred to hereinafter as “Chow 1”, and “A White-Box DES Implementation for DRM Applications”, by Stanley Chow, Phil Eisen, Harold Johnson, and Paul C. van Oorschot, in Digital Rights Management: ACM CCS-9 Workshop, DRM 2002, Washington, D.C., USA, Nov. 18, 2002, referred to hereinafter as “Chow 2”, disclose methods with the intent to hide the key by a combination of encoding its tables with random bijections representing compositions rather than individual steps, and extending the cryptographic boundary by pushing it out further into the containing application. When using these methods, it is difficult to change the key.

### SUMMARY OF THE INVENTION

It would be advantageous to have an improved system for updating cryptographic key data. To better address this concern, in a first aspect of the invention a system is presented that

comprises a memory for storing the cryptographic key data;

a key input for receiving sequential key updates; and

a key data updater for changing a portion of the cryptographic key data in response to a received one of the sequential key updates, the portion not including all the cryptographic key data, wherein different respective portions of the cryptographic key data are selected for respective ones of the sequential key updates.

The key update only changes a portion of the key data; hence, less information needs to be encapsulated in the key update. Thus less bandwidth is required for transmitting a key update. Still the system is relatively secure, because the key data updater causes different portions of the key data to be updated in response to the key updates. Hence, after a plurality of key updates, the number of changed bits is larger than the number of bits changed in an individual key update. This allows use of key updates that are relatively small compared to the size of the key data.

An embodiment comprises

a content input for receiving content data to be processed; and

a cryptographic unit for cryptographic processing of the content data in dependence on the key data to obtain processed content data.

Typically key management and cryptographic processing are executed in a single system.

In an embodiment, the content input is arranged for receiving a content data stream, successive portions of the content data stream being encrypted based on successive keys corresponding to the successive key updates. This makes the data stream more secure than when only one fixed key is used, while keeping the bandwidth for key updates relatively small.

In an embodiment, the content data stream comprises encrypted video data, the cryptographic unit being arranged for decrypting the encrypted video data; and further comprising an output for enabling a rendering of the decrypted video data. The system is particularly suitable for being implemented in video units, such as set-top boxes, digital video receivers and recorders, DVD players, and digital televisions.

In an embodiment, the key data comprises at least part of a look-up table. Look-up tables consist of individual entries that may be individually changed. Because look-up tables tend to occupy a lot of memory, it is advantageous to reduce the size of key updates in the way set forth. For example, pairs of entries in a look-up table may be swapped to maintain a bijective property of a look-up table.

In an embodiment, the key data comprises at least part of a network of look-up tables. Successive portions of a network of look-up tables may be changed, because the look-up tables consist of individual entries that may be individually changed. For example, one or more complete look-up tables are replaced or only some entries of one or more look-up tables are changed. Because networks of look-up tables tend to occupy a lot of memory, it is advantageous to reduce the size of key updates in the way set forth.

In an embodiment, the key update comprises a change to the at least part of the network of look-up tables. The key update is constructed for leaving unchanged at least one look-up table of the at least part of the network of look-up tables. A relatively easy way to implement the key updater and a key update generator is by leaving unchanged one or more complete look-up tables.

In an embodiment, the key update comprises a change to at most one look-up table of the at least part of the network of look-up tables. This further reduces the required bandwidth.

In an embodiment, the key data updater is arranged for selecting the portion in dependence on information comprised in the received one of the sequential key updates. This makes the system more flexible because it allows the provider of the key updates to decide which portions of the key data are changed.

In an embodiment, the key data updater is arranged for selecting the respective portions according to a predetermined sequence. This further reduces the required bandwidth because no information need be communicated about which portions to change.

An embodiment comprises a full key data updater for replacing all the key data in response to a key update in which it is indicated that all the key data should be replaced. This further improves the security, because the full key updater allows to completely replace all key data at one time. Because the system comprises both the key data updater and the full key data updater, full updates and partial updates can both be used to obtain any desired balance between bandwidth and security.

An embodiment comprises a server system for providing cryptographic key updates, the server system comprising

a key update generator for generating sequential key updates, wherein a respective one of the sequential key updates is indicative of a change to a respective portion of cryptographic key data, the portion not including all the cryptographic key data, wherein different respective portions of the cryptographic key data are selected for respective ones of the sequential key updates; and

a key output for providing the sequential key updates to a client system.

This server system provides the content and key updates received by the system set forth.

An embodiment comprises a method of updating cryptographic key data, the method comprising

storing the cryptographic key data;

receiving sequential key updates; and

changing a portion of the cryptographic key data in response to a received one of the sequential key updates, the portion not including all the cryptographic key data, wherein different respective portions of the cryptographic key data are selected for respective ones of the sequential key updates.

An embodiment comprises a method of providing cryptographic key updates, the method comprising

generating sequential key updates, wherein a respective one of the sequential key updates is indicative of a change to a respective portion of cryptographic key data, the portion not including all the cryptographic key data, wherein different respective portions of the cryptographic key data are selected for respective ones of the sequential key updates; and

providing the sequential key updates to a client system.

An embodiment comprises a computer program product comprising computer executable instructions for causing a processor to execute at least one of the methods set forth.

### BRIEF DESCRIPTION OF THE DRAWINGS

These and other aspects of the invention will be further elucidated and described with reference to the drawing, in which

FIG. 1 shows a diagram of an embodiment; and

FIG. 2 shows a diagram of an embodiment.

### DETAILED DESCRIPTION OF EMBODIMENTS

It is common in encrypted communications to regularly change the encryption keys. This helps to increase the security features of the communication system or to compensate for possible weaknesses in the particular encryption scheme used. In hostile conditions, where there is a risk that attackers are trying to break the encryption, key changes are an important tool to reduce the risk imposed by the attackers. Weaker encryption schemes are used in for example environments with limited resources with respect to computational power, so that a computationally intensive cryptographic scheme can't be used, or in environments with a demand for speed and using high bandwidth or throughput, so that the amount of data that needs to be processed is too large to be able to process all data according to a very strong cryptographic scheme.

Malicious users may be able to identify any potential weak spots of cryptographic schemes and use them to find the cryptographic keys or key-like elements. Therefore there is a need to protect these keys or key-like elements. One way to protect the keys or key-like elements is by regularly changing them. This complicates the use of any found keys or key-like elements, because they are valid only for a limited time.

A white-box implementation of cipher and key is a method to protect the key in general against such malicious users. To that end, the key is hidden in a plurality of look-up tables. Inputs and outputs of different look-up tables are connected to form a network of look-up tables. This is outlined in Chow 1 and Chow 2. However, in these systems, the key is fixed, and the key information is distributed throughout the network of look-up tables. A change of the key would require to replace the full network of look-up tables, which amounts to a relatively large amount of data. For example, a typical size for a cryptographic key is 128 bits, whereas the corresponding network of look-up tables would have a size of several kilobytes or megabytes. For example, consider a white-box implementation in which a key k expands to a plurality of tables T₀^{k}, . . . , Tₘ^{k} that depend on the key k. In a key-changing scheme using this white-box implementation, changing a key i into a different key j, results in replacing the sequence of tables T₀ⁱ, . . . , T₁ⁱ by the sequence of tables T₀^{j}, . . . , Tₘ^{j}.

In an embodiment, only a subset of the tables is replaced during a key change. This way, fewer data needs to be modified, which reduces bandwidth requirements and/or computational requirements. For example, starting with a key i and corresponding tables T₀ⁱ, . . . , Tₘⁱ, where m≧2, only tables T₀ⁱ and T₁ⁱ may be replaced with new information according to a new key j. The resulting table sequence T₀^{j}, T₁^{j}, T₂ⁱ, T₃ⁱ . . . , Tₘⁱ is a combination of both the original table sequence prior to the key change and the new tables that have been computed and/or communicated. Any subset of the plurality of tables may be changed as part of a key change. There might not exist any key k that expands into the modified table sequence T₀^{j}, T₁^{j}, T₂ⁱ, T₃¹ . . . , Tₘⁱ. Thus, more table sequences are possible than in the situation in which the table sequence is derived from a single key k. This results in a larger key space. Consequently the security may be increased.

In an embodiment, the key-changing scheme uses a sequence of keys k₀, k₁, k₂, . . . . Replacing every key kᵢ in this sequence with its associated tables according to their white-box implementations results in a sequence of white-box tables:

k₀, . . . , k₁, kⱼ, . . . →T₀^{k}^{₀}, . . . , Tₘ^{k}^{₀}, . . . , T₀^{k}^{ᵢ}, . . . , Tₘ^{k}^{ᵢ}, T₀^{k}^{ⱼ}, . . . , Tₘ^{k}^{ⱼ}, . . . .

In this embodiment, when a key change is required, the next table in this table sequence is used to replace one of the previously used tables. Only this next table needs to be transmitted. Following this scheme, the plurality of tables that is in use at successive key update times t₀, t₁, . . . tₘ₊₁ resulting in a gradual key change from a key i to a key j in m steps can be depicted as follows:

$$\begin{matrix}… , \underbrace{{T}_{0}^{i} , {T}_{1}^{i} , … , {T}_{m}^{i}}_{{t}_{0}} , {T}_{0}^{j} , {T}_{1}^{j} , … , {T}_{m}^{j} , … \\ … , {T}_{0}^{i} , \underbrace{{T}_{1}^{i} , … , {T}_{m}^{i} , {T}_{0}^{j}}_{{t}_{1}} , {T}_{1}^{j} , … , {T}_{m}^{j} , … \\ ⋮ \\ … , {T}_{0}^{i} , {T}_{1}^{i} , … , \underbrace{{T}_{m}^{i} , {T}_{0}^{j} , {T}_{1}^{j} , … , {T}_{m - 1}^{j}}_{{t}_{m}} , {T}_{m}^{j} , … \\ … , {T}_{0}^{i} , {T}_{1}^{i} , … , {T}_{m}^{i} , \underbrace{{T}_{0}^{j} , {T}_{1}^{j} , … , {T}_{m}^{j}}_{{t}_{m + 1}} , … .\end{matrix}$$

In the above notation, the horizontal braces indicate the tables that are in use after a key update. Note that while time progresses more and more of the tables corresponding to the key i are replaced by the tables corresponding to the key j. After m+1 steps a full migration from key i to key j is realized.

Within a second example the n^{th} table of key i is replaced by the n^{th} table of key j resulting in:

$$\begin{matrix}\underbrace{{T}_{0}^{i} , {T}_{1}^{i} , … , {T}_{m}^{i}}_{{t}_{0}} \\ \underbrace{{T}_{0}^{j} , {T}_{1}^{i} , … , {T}_{m}^{i}}_{{t}_{1}} \\ ⋮ \\ \underbrace{{T}_{0}^{j} , … , {T}_{m - 1}^{j} , {T}_{m}^{i}}_{{t}_{m}} \\ \underbrace{{T}_{0}^{j} , {T}_{1}^{j} , … , {T}_{m}^{j}}_{{t}_{m + 1}} .\end{matrix}$$

It is noted that additional security may be provided by considering that it may be difficult for an attacker to know how messages that contain key information should be applied at the receiver of such messages. To apply such a message, the attacker has to find out the values of updated look-up table entries and which of the look-up table entries are being updated. Depending on the protocol used, this may be a difficult task. For example, the look-up tables are updated in a predetermined order that is known to both the sender and the receiver, but the implementation of the receiver is such that it is difficult to uncover this order by inspecting the implementation of the receiver. This way, although the attacker is able to find out values of a new look-up table, he remains unaware of how to incorporate this new look-up table in the existing network of look-up tables. By providing different (types of) receivers with different protocols regarding the order in which look-up table entries are updated, it is made possible that content targeted at one particular (type of) receiver cannot be used at another (type of) receiver.

In an embodiment, by replacing the key in steps, the key space is enlarged. For example, when a 128-bit AES key is changed by replacing its ten 128-bit round keys one by one, the key space is enlarged by roughly 10 times, because the nine intermediate steps have round keys corresponding to both the old and the new 128-bit AES key; consequently these intermediate steps do not necessarily correspond to any single 128-bit AES key. This may further improve the security of the system. It is also possible to further enlarge the key space by selecting the round keys individually rather than by computing them from a 128-bit AES key.

In an embodiment, wherein the key comprises a sequence of random bits, each key update comprises an update of a subset of the random bits; for example, in a 128-bit key, each key update comprises an update of 8 bits. The first key update updates the first 8 bits of the 128-bit key; the second key update updates the second 8 bits of the 128-bit key; and so on. The size of the key, the order in which the bits are updated and the number of bits that get updated are only given here as examples.

In an embodiment, an encryption scheme is used that expands a mother key into a plurality of parameters (for example: round keys); the plurality of parameters comprising more bits than the mother key. Each key update comprises a change to one or more of the plurality of parameters.

In an embodiment, a white-box implementation is used to implement a cryptographic scheme. In this white-box implementation, the cryptographic scheme is implemented by means of a network of look-up tables. The key information that would describe the key of the cryptographic scheme is distributed throughout the network of look-up tables. Rather than changing the key (which would imply a changing a lot of the look-up tables), each key update comprises information to replace an individual look-up table. The successive key updates preferably update different look-up tables. Alternatively, each key update comprises information to replace only some but not all of the look-up tables. Preferably, care is taken to ensure that any desirable cryptographic properties of the cryptographic scheme are maintained in the changed network of look-up tables.

For example, a key update may comprise information for replacing all look-up tables involved in computing a round of a cryptographic scheme (for example a round of AES or a round of DES). This allows to easily change a round key.

An embodiment comprises a white-box implementation as described in International Application Serial No. PCT/IB2007/050640 (attorney docket PH005600). In this document, a method of protecting an integrity of a data processing system is disclosed. The method comprises determining a data string to be protected, an integrity of the data string being an indication of the integrity of the data processing system. A set of parameters is computed representing a predetermined data processing function, using a redundancy in the set of parameters to incorporate the data string into a bit representation of the set of parameters. The system is enabled to process data according to the set of parameters. The set of parameters represents at least part of a cryptographic algorithm including a cryptographic key. The set of parameters also represents a network of look-up tables. The network of look-up tables comprises a plurality of look-up tables of a white-box implementation of a data processing algorithm. The data processing algorithm comprises a cryptographic algorithm.

According to this method, some of the look-up tables are defined at least partly by a data string to be protected. The remaining look-up tables are adapted to accommodate this. In this case, the key updates are selected such that the changed network of look-up tables still accommodates the data string to be protected.

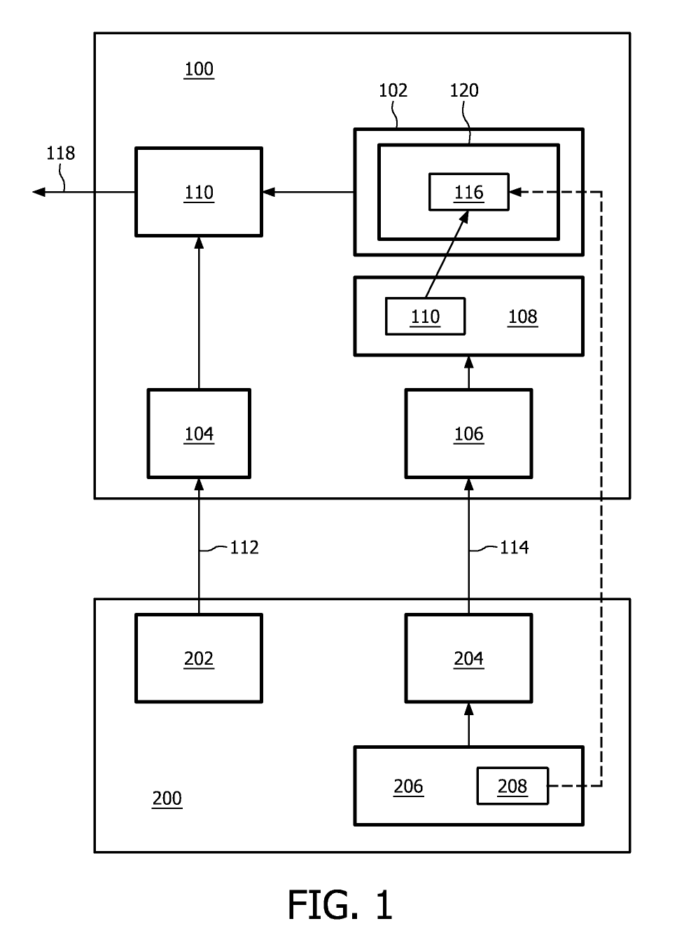

FIG. 1 illustrates an embodiment. The Figure illustrates a system 100 for improving data security. The system 100 is for example a personal computer executing a software application, or a set-top box or television. The system 100 comprises a memory 102 for storing key data 120. The memory 102 can be any type of volatile or nonvolatile memory, including flash memories and disc memories. System 100 further comprises a content input 104 for receiving content data 112 to be processed. This input is for example arranged for retrieving data from an internet connection to a content data server, or for retrieving digital audio and/or video signals from a satellite dish or a cable television connection. The data may also be obtained from a storage medium for example a removable storage medium such as a DVD.

System 100 further comprises a key input 106 for receiving successive key updates. These key updates 114 are for example digital communication messages. These key updates may be received via the same cable and/or connection as the content data 112. Alternatively separate physical connections are used for the content data 112 and the key updates 114. The received key updates 114 are forwarded to a key data updater 108 for changing successive portions 116 of the key data 120 as defined by the key updates 114. After processing a predetermined number of these key updates 114, a total portion of the key data has been changed that is larger than one of the successive portions 116. A means 110 is provided in the key data updater 108 to identify the respective successive portions 116 of the key data 120. This means 110 may parse the key update for information about which portion 116 is to be updated. The means 110 may also select the portions 116 according to a fixed scheme. The content data 112 is processed by a cryptographic unit 110 in dependence on the key data 120 to obtain processed content data 118.

In an embodiment, a system comprising the key input 106 and the key updater 108 are implemented as a separate entity such as a smart card. This smart card may also comprise the memory 102 and provide the updated key as an output.

In an embodiment, the content input 104 is arranged for receiving a content data stream 112, successive portions of the content data stream 112 being encrypted based on successive keys corresponding to the successive key updates 114; the cryptographic unit 110 being arranged for decrypting the successive portions of the content data stream 112 based on the successive keys stored as key data 120 in the memory 102. The successive keys correspond to the successive key updates 114.

In an embodiment, the key data 120 comprises at least part of a look-up table.

In an embodiment, the key data 120 comprises at least part of a network of look-up tables. The key update 114 comprises a change to the at least part of a network of look-up tables. The key update 114 leaves unchanged at least one look-up table of the at least part of a network of look-up tables. For example, the key update comprises a change to at most one look-up table of the at least part of a network of look-up tables.

In an embodiment, the system 100 further comprises a full key data updater for replacing all the key data in response to a key update in which it is indicated that all the key data should be replaced. This allows to reset the complete key with a single key update.

In an embodiment, the content data 112 comprises encrypted video data, the cryptographic unit 110 being arranged for decrypting the encrypted video data; and further comprising an output for enabling a rendering of the decrypted video data 118.

An embodiment comprises a server system 200 for improving data security. The server system is for example operated by a content provider or broadcast company or cable television operator or satellite television operator. The server system comprises a content output 202 for providing content data 112 to be processed by a client system 100 in dependence on key data 120 in the client system. A key output 204 provides successive key updates 114 to the client system. The server system 200 further comprises a key update generator 206 for generating the successive key updates 114. Each successive key update 114 comprises information for changing successive portions 116 of the key data 120 stored in a memory 102 of the client system 100, wherein after a predetermined number of replacements preferably all of the key data 120 has been replaced, the predetermined number of replacements being larger than one. These successive portions are identified by a means 208 in the key update generator 206.

An embodiment relating to a method of improving data security comprises storing key data 120; receiving content data 112 to be processed; receiving successive key updates 114; changing successive portions 116 of the key data in response to the successive key updates, wherein after a predetermined number of replacements all of the key data has been replaced, the predetermined number of replacements being larger than one; and cryptographic processing of the content data in dependence on the key data to obtain processed content data 118.

An embodiment relating to a method of improving data security comprises providing content data to be processed by a client system 100 in dependence on key data 120 in the client system; providing successive key updates 114 to the client system; and generating the successive key updates, wherein each successive key update comprises information for changing successive portions 116 of the key data, wherein after a predetermined number of replacements all of the key data has been replaced, the predetermined number of replacements being larger than one.

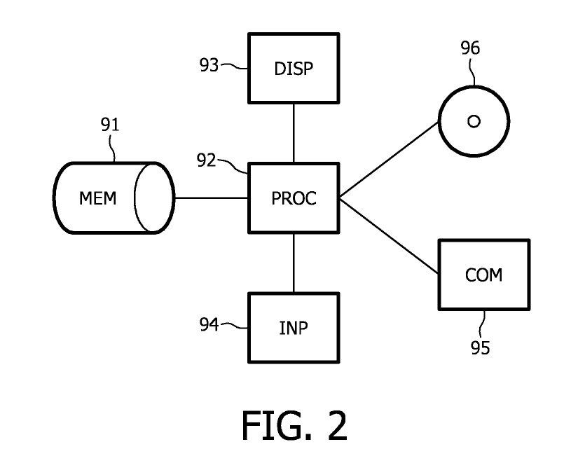

FIG. 2 illustrates an example hardware architecture suitable for implementing the system as set forth. The hardware architecture may be implemented in, for example, a personal computer, a set-top box, a television set, or a digital video player/recorder. The figure shows a processor 92 for controlling memory 91, display 93 (or a connector for a display), input 94 (e.g. keyboard, mouse, remote control), communications port 95 (e.g. Ethernet, wireless network, antenna cable input), and storage medium 96 (e.g. a removable storage medium such as a compact disc, CD-ROM, DVD, external flash memory, or an internal nonvolatile storage medium such as a hard disc). The memory 91 comprises computer instructions for causing the processor to perform one or more of the methods set forth. These computer instructions may be loaded into the memory 91 from the storage medium 96 or from the Internet via communications port 95. The input 94 is used to enable a user to interact with the system. The display is used for interaction with the user and optionally for rendering video or still images. Loudspeakers (not shown) may also be provided for user interaction and/or rendering audio content. Both the server system and the client system may be implemented as software applications on the same hardware system of FIG. 2, and they may run simultaneously and communicate with one another via inter-process communication. Alternatively, the client and server may run on separate hardware systems, having an architecture similar to FIG. 2. For example the server is located and owned by a content provider and the client is owned by a consumer and located in a consumer home.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system (100) for updating cryptographic key data (120), the system comprising
a memory (102) for storing the cryptographic key data (120);
a key input (106) for receiving sequential key updates (114); and
a key data updater (108) for changing a portion (116) of the cryptographic key data in response to a received one of the sequential key updates (114), the portion not including all the cryptographic key data, wherein different respective portions of the cryptographic key data are selected for respective ones of the sequential key updates.

2. The system according to claim 1, further comprising
a content input (104) for receiving content data (112) to be processed; and
a cryptographic unit (110) for cryptographic processing of the content data in dependence on the key data to obtain processed content data (118).

3. The system according to claim 2, wherein the content input is arranged for receiving a content data stream, successive portions of the content data stream being encrypted based on successive keys corresponding to the successive key updates.

4. The system according to claim 3, wherein the content data stream comprises encrypted video data, the cryptographic unit being arranged for decrypting the encrypted video data; and further comprising an output for enabling a rendering of the decrypted video data.

5. The system according to claim 1, wherein the key data comprises at least part of a look-up table.

6. The system according to claim 1, wherein the key data comprises at least part of a network of look-up tables.

7. The system according to claim 6, wherein the key update comprises a change to the at least part of the network of look-up tables and wherein the key update is constructed for leaving unchanged at least one look-up table of the at least part of the network of look-up tables.

8. The system according to claim 7, wherein the key update comprises a change to at most one look-up table of the at least part of the network of look-up tables.

9. The system according to claim 1, wherein the key data updater is arranged for selecting the portion in dependence on information comprised in the received one of the sequential key updates.

10. The system according to claim 1, wherein the key data updater is arranged for selecting the respective portions according to a predetermined sequence.

11. The system according to claim 1, further comprising a full key data updater for replacing all the key data in response to a key update in which it is indicated that all the key data should be replaced.

12. A server system (200) for providing cryptographic key updates, the server system comprising
a key update generator (206) for generating sequential key updates (114), wherein a respective one of the sequential key updates is indicative of a change to a respective portion (116) of cryptographic key data (120), the portion not including all the cryptographic key data, wherein different respective portions of the cryptographic key data are selected for respective ones of the sequential key updates; and
a key output (204) for providing the sequential key updates (114) to a client system (100).

13. A method of updating cryptographic key data (120), the method comprising
storing the cryptographic key data (120);
receiving sequential key updates (114); and
changing a portion (116) of the cryptographic key data in response to a received one of the sequential key updates (114), the portion not including all the cryptographic key data, wherein different respective portions of the cryptographic key data are selected for respective ones of the sequential key updates.

14. A method of providing cryptographic key updates, the method comprising
generating sequential key updates (114), wherein a respective one of the sequential key updates is indicative of a change to a respective portion (116) of cryptographic key data (120), the portion not including all the cryptographic key data, wherein different respective portions of the cryptographic key data are selected for respective ones of the sequential key updates; and
providing the sequential key updates (114) to a client system (100).

15. A computer program product comprising computer executable instructions for causing a processor to execute the method according to claim 13.
